(19) United States
(12) Patent Application Publication
(10) Pub. No.: US 2017/0282859 A1
(43) Pub. Date: Oct. 5, 2017

(54) ON-SALE VEHICLE SHARING ACCESSORY DEVICE AND SYSTEM

(71) Applicant: GM GLOBAL TECHNOLOGY OPERATIONS LLC, Detroit, MI (US)

(72) Inventors: Donald K. Grimm, Utica, MI (US); Paul H. Pebbles, Novi, MI (US); Robert Miles, Austin, TX (US); Ramie Phillips, III, Rochester Hills, MI (US); Travis J. Ryan, Austin, TX (US); Xi Ju, Troy, MI (US); Pavan K. Namineni, Ann Arbor, MI (US); Christopher L. Oesterling, Troy, MI (US); Anil Bika, Rochester Hills, MI (US); Nicholas P. Irish, Commerce, MI (US); John A. Cafeo, Farmington, MI (US); James Lemieux, Royal Oak, MI (US)

(73) Assignee: GM GLOBAL TECHNOLOGY OPERATIONS LLC, Detroit, MI (US)

(21) Appl. No.: 15/629,137

(22) Filed: Jun. 21, 2017

Related U.S. Application Data
(63) Continuation-in-part of application No. 15/291,378, filed on Oct. 12, 2016.
(60) Provisional application No. 62/270,798, filed on Dec. 22, 2015.

(51) Int. Cl. B60R 25/24; H04W 12/04; H04W 88/02; H04W 12/08; H04W 4/12; H04W 4/00; G06Q 30/06; H04L 9/32

(52) U.S. Cl. CPC B60R 25/241; G06Q 30/0609; H04W 12/04; H04L 9/3213; H04W 12/08; H04W 4/12; G06Q 30/0635; H04W 4/008; H04W 88/02; G06Q 30/06

(57) ABSTRACT

Systems and methods disclosed herein include providing an on-sale vehicle, receiving an access request for the on-sale vehicle from a buyer, approving the access request, transmitting at least one authentication key, confirming an identity of the buyer, initiating a test drive, monitoring the test drive, and completing a transaction upon conclusion of the test drive including revoking the at least one authentication key in response to the buyer not purchasing the on-sale vehicle or revoking an authentication key of a prior titleholder in response to the buyer purchasing the on-sale vehicle.

### CROSS-REFERENCE TO RELATED APPLICATIONS

This application is a continuation-in-part of U.S. patent application Ser. No. 15/291,378, filed Oct. 12, 2016, which claims the benefit of U.S. Provisional Application No. 62/270,798, filed Dec. 22, 2015, each of which is hereby incorporated by reference in its entirety.

### INTRODUCTION

The disclosure relates to the field of on-sale vehicles and, more specifically, to systems, methods, and devices for on-sale vehicle sharing.

Modern vehicles may offer remote keyless or passive entry/start systems. For example, a keyfob can be used to wirelessly access vehicle functions. The vehicle may include a physical key to start and operate the vehicle or may use the keyfob to authorize engine starting and operating functions as long as it is proximate the vehicle.

Sale of a vehicle requires that a potential buyer meet with a seller such as a vehicle owner or agent of the vehicle owner. The potential buyer is generally not known to the seller until meeting with the seller. Prior to providing the potential buyer with keys to the vehicle, the seller seeks to increase the security of the transaction by running checks on the potential buyer such as verifying the buyer's ID, assessing the ability to purchase the vehicle, etc. These checks add time to the transaction because they are performed while the potential buyer is on-site with the seller. Further, the checks may need to be run multiple times, even if the potential buyer is returning to the same seller. Moreover, if the transaction is not completed because of an issue uncovered during these checks, both the seller and buyer have lost opportunity time such as travel time, inability to correspond with other potential buyers, etc.

Prior to sale of the vehicle, both the potential buyer and seller have to meet so the seller may provide keys to the buyer to access the vehicle and enable vehicle operations. The vehicle is typically kept very near to the seller to minimize inconvenience to the seller during the transaction. However, the buyer must travel to the seller's physical location to receive the keys. If the vehicle is stored off-site, then the buyer and seller may be even more inconvenienced by having to travel to yet another location.

### SUMMARY

It is desirable to provide added security and convenience to the selling process. Systems and methods disclosed herein may provide for credentials of the potential buyer to be generated without requiring the buyer to travel to the seller's location. Systems and methods disclosed herein may provide for credentials of a potential buyer to be verified at the vehicle location without requiring the seller to be physically present. Systems and methods disclosed herein may provide for the seller to obtain a higher price for a vehicle by reducing the costs and/or number of parties involved in transferring a vehicle from one vehicle user to the next vehicle user. Systems and methods disclosed herein may provide the vehicle user with continued use of the vehicle during the sale process. Systems and methods disclosed herein may provide real-time monitoring of a test drive without the seller being physically present in the vehicle during the test drive. Systems and methods disclosed herein may provide interaction between the potential buyer and the seller during a test drive without the seller being physically present. Systems and methods disclosed herein may provide for completing purchase and transfer of title at the vehicle without requiring the buyer and seller to physically meet.

According to aspects of the present disclosure, a method includes receiving an access request for an on-sale vehicle, approving the access request, transmitting at least one authentication key, confirming an identity of a buyer, monitoring a test drive, and completing a transaction upon conclusion of the test drive. The access request is received in response to selection by the buyer. The access request is approved in response to seller input received via the vehicle-administration module. The authentication keys are transmitted to at least one of the portable wireless communication device and the plug-in device and are transmitted in response to approving the access request. The identity of the buyer is confirmed in response to an access notification received by the administrative system. The test drive is monitored via the driver-monitoring module. Completing the transaction upon conclusion of the test drive includes either revoking the at least one authentication key in response to the buyer not purchasing the on-sale vehicle or revoking an authentication key of a prior titleholder in response to the buyer purchasing the on-sale vehicle.

According to further aspects of the present disclosure, the method further includes performing an initial setup of the plug-in device in the vehicle including pairing the plug-in device as an additional keyfob to the vehicle. The pairing includes coupling the plug-in device to a service communication port of the vehicle, accessing a vehicle communication platform (VCP) of the vehicle, pairing the plug-in device to a passive entry/passive start system of the vehicle, requesting cryptography keys from a remote entity via the VCP for validation between the plug-in device and the passive entry/passive start system, and successfully pairing the plug-in device to the passive entry/passive start system for ongoing communication between the plug-in device and passive entry/passive start system.

According to further aspects of the present disclosure, the prior titleholder maintains access to and personal use of the on-sale vehicle prior to the buyer purchasing the on-sale vehicle.

According to further aspects of the present disclosure, the authentication key of the prior titleholder is contained within a keyfob.

According to further aspects of the present disclosure, approving the access request includes automatically approving the access request via an approval module in response to the access request meeting one or more predetermined criteria.

According to further aspects of the present disclosure, the predetermined criteria include vehicle availability.

According to further aspects of the present disclosure, confirming the identity of the buyer includes use of a driver-facing camera installed within the vehicle.

According to further aspects of the present disclosure, confirming the identity of the buyer includes capturing, via the driver-facing camera, an image of an identification card presented to the driver-facing camera.

According to further aspects of the present disclosure, confirming the identity of the buyer includes capturing, via the driver-facing camera, an image of a face of the buyer and comparing, via the administrative system, the image to a known image of the face of the buyer.

According to further aspects of the present disclosure, registering a buyer; providing indicia of an on-sale vehicle matching search criteria entered by the buyer; and initiating a test drive of the on-sale vehicle. Registering the buyer is performed via an administrative system. Indicia of the on-sale vehicle is provided in response to a query initiated by the buyer. The test drive is initiated in response to confirming the identity of the buyer. The plug-in device is configured to enable vehicle access and vehicle operations for the on-sale vehicle.

According to further aspects of the present disclosure, initiating the test drive of the on-sale vehicle includes voice communication with the seller.

According to further aspects of the present disclosure, the voice communication with the seller occurs via a video call using a driver-facing camera installed within the on-sale vehicle.

According to further aspects of the present disclosure, the video call includes display of the seller via a video display within the on-sale vehicle.

According to further aspects of the present disclosure, monitoring the test drive of the on-sale vehicle via the driver-monitoring module includes using a telematics module to track location and/or other information of the on-sale vehicle during the test drive.

According to further aspects of the present disclosure, monitoring the test drive of the on-sale vehicle via the driver-monitoring module includes transmitting images captured by a front-facing vehicle camera to the seller.

According to further aspects of the present disclosure, the method further includes automatically modifying a vehicle setting unrelated to vehicle performance in response to a seller input via the vehicle-administration module.

According to further aspects of the present disclosure, the vehicle setting includes actuation of exterior lights.

According to further aspects of the present disclosure, monitoring, via a driver-monitoring module, the test drive of the on-sale vehicle is performed by the seller, and the seller simultaneously monitors, via a second driver-monitoring module, a second test drive of a second on-sale vehicle.

According to further aspects of the present disclosure, completing, upon conclusion of the test drive, the transaction further includes transmitting, via a communication module, data describing the test drive to the seller.

According to further aspects of the present disclosure, completing, upon conclusion of the test drive, the transaction further includes transmitting, via a communication module, data describing the test drive to the buyer.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 is a schematic illustration of a communication flow diagram between communicating entities, according to aspects of the present disclosure.

FIG. 2 is a schematic flowchart for reserving and authorizing use of the vehicle, according to aspects of the present disclosure.

FIG. 3 is a schematic flow diagram for initial setup of a plug-in device.

FIG. 4 is a schematic flow diagram for reservation of a vehicle.

FIG. 5 is a schematic flow diagram for detection and authorization of the buyer based on an approaching portable wireless communication device.

FIG. 6 is a schematic flow diagram for executing vehicle functions via the portable wireless communication device.

FIG. 7 is a schematic flow diagram for executing driving functions of the vehicle.

FIG. 8 is a schematic flow diagram for securing the vehicle upon a completed trip.

FIG. 9 is a schematic flowchart for executing vehicle command functionality between the portable wireless communication device and the plug-in device.

### DETAILED DESCRIPTION

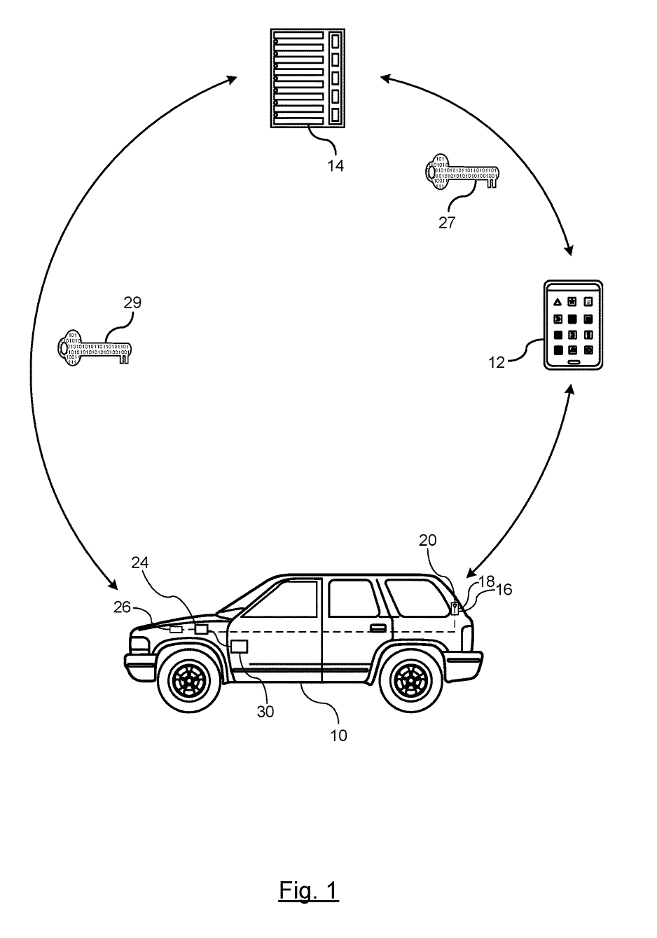

FIG. 1 illustrates a vehicle sale system including a vehicle 10, a portable wireless communication device 12, and an administrative system 14. The portable wireless communication device 12 is configured to communicate with both the vehicle 10 and the administrative system 14. In some aspects, the portable wireless communication device 12 is a smart phone, tablet, or the like.

The vehicle 10 is equipped with at least one accessory device including at least one plug-in device 16, a wireless communication module 18, a body control module 24, and a vehicle communication platform 26. The plug-in device 16 is configured to provide keyfob functions such as entry functions, vehicle start functions, and operating functions. The plug-in device 16 includes a central processing unit and can either be removably plugged into a service communication port of the vehicle, such as on-board diagnostic port 30, or permanently installed as part of the vehicle architecture during manufacturing or in an aftermarket modification. Beneficially, a removable accessory device reduces cost of installation, increases vehicle security because the device can be removed while the vehicle 10 is not being offered for sale, and can reduce a seller's costs because the seller is able to remove and retain the plug-in device 16 for later use on another vehicle.

The accessory device includes security mechanisms that protect against unauthorized usage or theft via built in mechanisms that disable remote keyless functions unless an authorization is received (e.g., the remote keyless electronics of the hardware are not powered unless a valid token has been received from a connecting phone and/or remote server entity). The plug-in device 16 replaces the physical keyfob functionality of storing an authorization key. Generating the passive commands can be performed utilizing the plug-in device 16, which acquires the necessary keys as described herein for enabling and executing vehicle operations. To obtain the authorization keys, the administrative system 14 issues the public keys 27 and 29 to both the portable device 12 and optionally to the plug-in device 16. Alternatively, other schemes in addition to public key cryptography may be utilized. When the user approaches the vehicle 10 with the portable wireless communication device 12, the phone sends a secure package to the accessory device. The secure package can be validated as originating from both the administrative system 14 and the phone (e.g., verifying digital signatures of the key and command request). In aspects utilizing public keys, the token that originates from the smart phone includes two layers of encapsulated information. An outer layer of the token is the “command request” (e.g., lock, unlock, etc.) and is signed by the smart phone's public key. An inner layer of the token is the “digital key” and includes an unmodified server-signed object, which provides a cleartext package of the allowed operations, constraints (e.g., allowed time frames for operation, allowed geographic limits for operation, etc.), the smart phone's public certificate\key 27, and other server information. The public key 29 that is installed onto the device can be used so that the entire package (e.g., the digital key from the remote server and the command request from the phone) can be validated such that each has originated from the true party. The plug-in device 16 and the portable wireless communication device 12 can authenticate one another for vehicle access and operation.

The wireless communication module 18 is configured to communicate with the portable wireless communication device 12 via an antenna. In some aspects, the wireless communication module 18 is a low-energy Bluetooth (“BLE”) module. In some aspects, the antenna is a single antenna.

In some aspects, the accessory device includes a plurality of individual printed circuit boards (“PCBs”) (e.g., the plug-in device 16 is a first PCB and the wireless communication module 18 is a second PCB). In some aspects, the accessory device includes a single PCB (e.g., the plug-in device 16 and the wireless communication module 18 share a PCB and are communicably connected through traces).

The body control module 24 is configured to provide various functions associated with the vehicle body. The functions associated with the vehicle body include lock and unlock functionality, trunk or tailgate release, actuating the horn, remote start and engine start/stop functionality during typical communications with remote keyless entry or passive systems.

The vehicle communication platform 26 is configured to provide communication between the accessory device and the administrative system 14. In some aspects, the vehicle communication platform 26 provides a WiFi hotspot that is accessible by the accessory device as a communication medium for use as an additional authentication mechanism (e.g., the accessory device may check for agreement between the authentication provided by the smartphone and what is provided by the administrative system 14). In some aspects, the accessory device includes a dedicated long-range communication platform to provide communication between the accessory device and the administrative system 14 without being operatively coupled to the vehicle communication platform 26.

Beneficially, using the accessory device of the present disclosure, a physical key or a keyfob is not required for passive vehicle operation and engine start, which allows any potential buyer to be provided with access to the vehicle 10 through a registration and authorization process utilizing their wireless communication device 12 (e.g., smart phone).

In some aspects, the at least one accessory device further includes an on-sale module 20 configured to communicate with the administrative system 14.

The on-sale module 20 includes a credential-validation module and a driver-monitoring module communicatively coupled to a driver-facing camera. The driver-facing camera is oriented toward a front of the driver and is configured to capture images of a potential buyer seated in the driver seat of the vehicle to identify the user. In some aspects, the on-sale module 20 includes a sale-transaction module configured to accept payment information from the potential buyer. The payment information can include, for example, an electronic payment such as a credit card. The payment can be made, for example, to place a security deposit on the vehicle, to purchase the vehicle, or to pay for damage incurred during the trip.

The credential-verification module is configured to authenticate the potential buyer's identity. In some aspects, the potential buyer is authenticated after entering the vehicle. In some aspects, the potential buyer is authenticated contemporaneously with entering the vehicle. In some aspects, the credential-verification module authenticates the potential buyer's identity using a state-issued identification card, biometric software, facial recognition, combinations thereof, and the like.

The driver-monitoring module is configured to monitor the potential buyer's use of the vehicle. In some aspects, the driver-monitoring module receives driver-facing camera data, vehicle camera data (such as a front-facing camera), speedometer data, odometer data, GPS data, combinations thereof, and the like. In some aspects, the administrative system 14 is further coupled to one or more of a vehicle-administration module, a credit-validation module, a vehicle-valuation module, a license-validation module, a telematics module, combinations thereof, and the like. The vehicle-administration module is configured to allow a seller to monitor vehicle usage, view requests, and approve or deny access to the vehicle. In some aspects, the vehicle-administration module is further configured to allow the seller to view data received by the administrative system 14 by the other modules, such as a current vehicle value, a forecasted vehicle value, buyer ratings, buyer creditworthiness, and the like.

The credit-validation module is configured to validate the buyer's creditworthiness. In some aspects, the administrative system 14 is configured to provide a potential buyer with a list of all on-sale vehicles 10 matching selected criterion. In some aspects, if the potential buyer selects a vehicle 10 that is outside of the potential buyer's creditworthiness, the credit-valuation module automatically generates a communication to the buyer. The communication may include, for example, the creditworthiness threshold or other criteria that the buyer should achieve prior to being qualified to test or purchase the vehicle 10. In some aspects, the administrative system 14 is configured to modify a list of on-sale vehicles 10 returned to the potential buyer by removing unapproved vehicles based on the buyer's creditworthiness. Beneficially, modifying the list of approved vehicles or providing a list consisting essentially of approved vehicles reduces the number of buyer requests for a seller to review. Beneficially, this improves transactional efficiency by reducing the risk of repossession by the seller and derogatory marks on the buyer's credit history.

The vehicle-valuation module is configured to provide a valuation of the vehicle 10. The vehicle-valuation module may receive, for example, an estimated value of the vehicle 10 based on make, model, year, mileage, usage history, combinations thereof, and the like. The vehicle-valuation module may also receive, for example, promotions for particular vehicles or types of vehicles offered by OEMs, finance organizations, third-parties, and the like.

The license-validation module is configured to validate the buyer's driving credentials. In some aspects, the administrative system 14 allows the buyer to view only vehicles that the buyer may legally drive. In some aspects, the telematics module is configured to provide location of the vehicle 10 before, during, and/or after operation.

In some aspects, one or more of the modules coupled to the administrative system 14 is operated and maintained by more than one provider. For example, state agencies may provide data for the license-validation module, while the vehicle original equipment manufacturer provides data for the vehicle-valuation module.

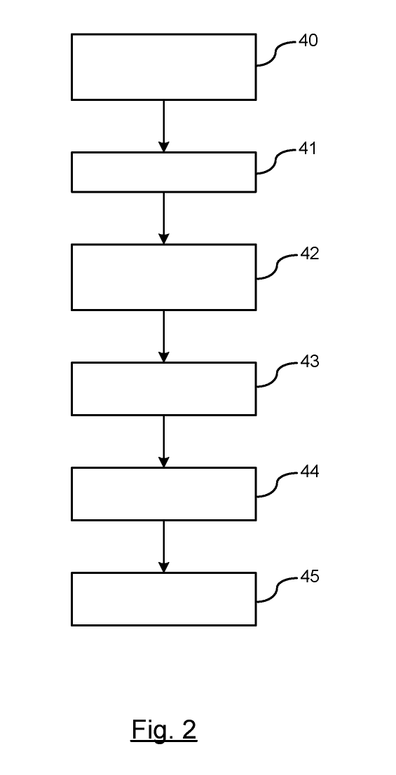

FIG. 2 is an overview of a process for reserving and authorizing use of the vehicle 10. In block 40, as an initial setup, the plug-in device 16 is added (e.g., paired as an additional keyfob) to the vehicle.

In block 41, registration is performed for a buyer to reserve the vehicle 10 currently located at a respective parking location utilizing an application on the smart phone. The vehicle may be parked at any location and may be located by the buyer through, for example, GPS/Navigation. In some aspects, the GPS of the buyer's portable wireless communication device 12 is used to view available vehicles nearby. The buyer, via smart phone, creates a registration for a respective vehicle by providing various details including device identification, user name, and reservation details.

In block 42, authorization of the buyer is executed between the portable wireless communication device 12 of the buyer and the plug-in device 16.

In block 43, upon a successful authorization, keyfob functions such as lock, unlock, and passive start are enabled based on requests between the portable wireless communication device 12 and the plug-in device 16.

In block 44, passive start is enabled based on a successful sensing of the portable wireless communication device 12 in the vehicle and the buyer actuating a start/stop pushbutton. Remote start may be performed when the buyer is exterior of the vehicle during the authorization stage where the portable wireless communication device 12 communicates with the administrative system 14 to actuate the remote start as opposed to the sensing the portable wireless communication device 12 within a close proximity to the vehicle and actuating the start/stop pushbutton.

In block 45, upon completion of the trip, the vehicle is turned off, the vehicle is secured, and the authorization keys are wiped clean so that the vehicle cannot be utilized without issuing new authorization keys.

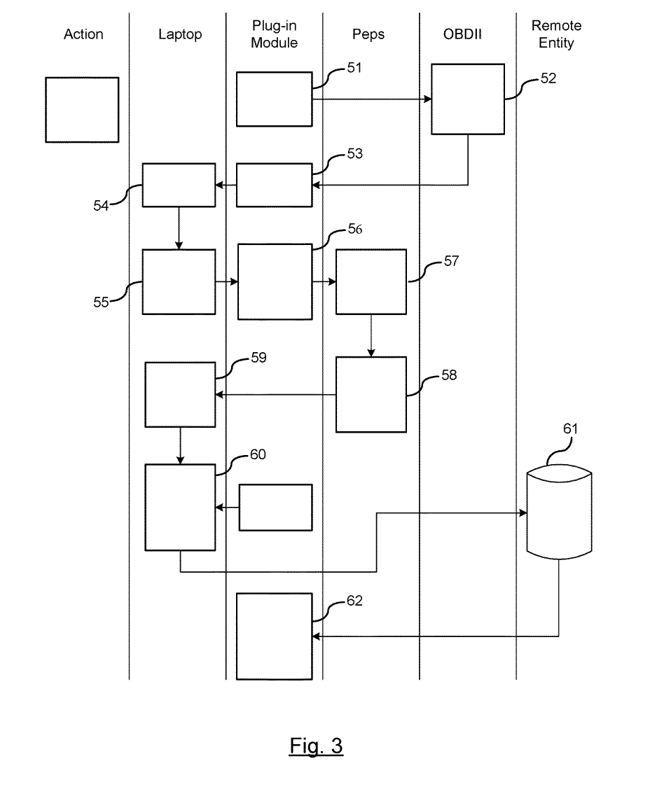

FIG. 3 represents a flow diagram for an initial setup of the plug-in device 16 in the vehicle 10 as described earlier in block 40. Upon installing the plug-in device 16 in the vehicle 10, the plug-in device 16 may be paired with the vehicle 10 as an additional remote keyless device.

In block 51, the vehicle setup is initiated and the accessory device is connected to the on-board diagnostic port 30, assembly line diagnostic link, or other available connection.

In block 52, the on-board diagnostic port 30 provides power to the accessory device.

In block 53, ignition is turned on.

In block 54, if the accessory device utilizes communications provided by an in-vehicle WiFi hotspot, a communication link of the vehicle 10 is coupled to, for example, a personal computer such as a laptop to establish a communication between the accessory device and the personal computer.

In block 55, a Wi-Fi service set identifier (SSID) may be entered into the accessory device to provide it with Internet access via the built-in vehicle hotspot. The SSID is a sequence of characters that uniquely names a wireless local area network (WLAN).

In block 56, the accessory device is paired with the WiFi hotspot and connection between the WiFi hotspot and the accessory device is confirmed as part of the installation procedure.

In block 57, a respective antenna is connected to the passive entry/passive start device. In block 58, the passive entry/passive start device is paired to the accessory device. In this block, the accessory device gets added as an additional fob to the vehicle 10. For example, a respective vehicle 10 may allow you to add up to 8 keyfobs that are recognized by the vehicle 10 and a pairing process is performed by a customer or other personnel such as a service technician. As a result, the accessory device will be added as an additional fob.

In block 59, a valid passive entry/passive start connection is confirmed by the personal computer. This block validates that the fob was successfully paired and is functional. In block 60, additional information of the wireless communication module 18, such as a node ID, is collected from the wireless communication module 18 and is provided to the laptop for fleet management purposes.

In block 61, the administrative system 14 is contacted to provide keys to perform cryptography validation by pairing the vehicle 10 and the accessory device via the administrative system 14.

In block 62, delivery of an end-to-end cryptography key from the administrative system 14 to the accessory device is validated. As a result, the accessory device is paired with the vehicle 10 and can access the passive entry/passive start functionality for ongoing communication between the respective devices of the vehicle 10.

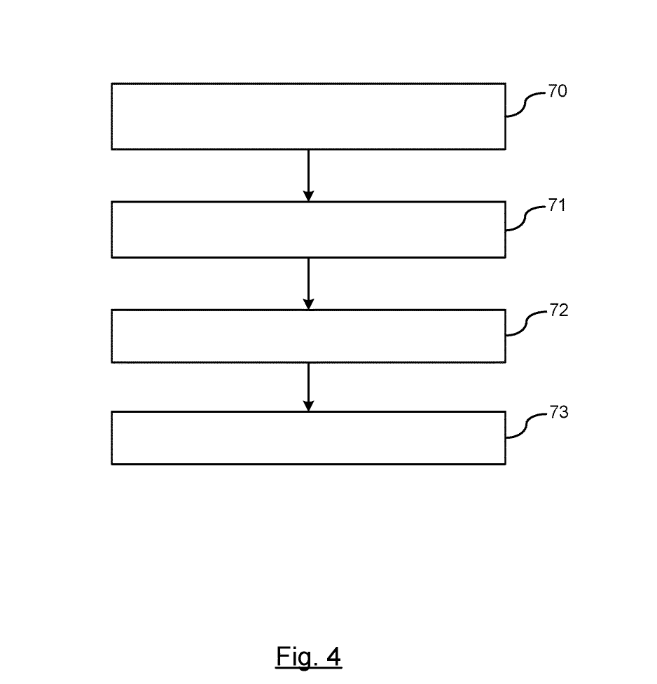

FIG. 4 represents a flow diagram for reservation by the buyer utilizing the portable wireless communication device 12 as described earlier in block 41.

In block 70, the buyer utilizing a mobile application creates a reservation. The registration includes, but is not limited to, a device ID (e.g., smart phone identifier), username, and reservation details.

In block 71, the administrative system 14 generates a signed access token for the registration. The access token is transmitted to the portable wireless communication device 12 via the mobile application within a predetermined period of time from the registration request. The signed access token may include a universal unique identifier (UUID) of the wireless communication module 18, time range, and timestamp.

In block 72, the mobile application opens and the buyer selects the start reservation option.

In block 73, a confirmation and access token is sent to the portable wireless communication device 12 and the confirmation is sent to the buyer via the mobile application.

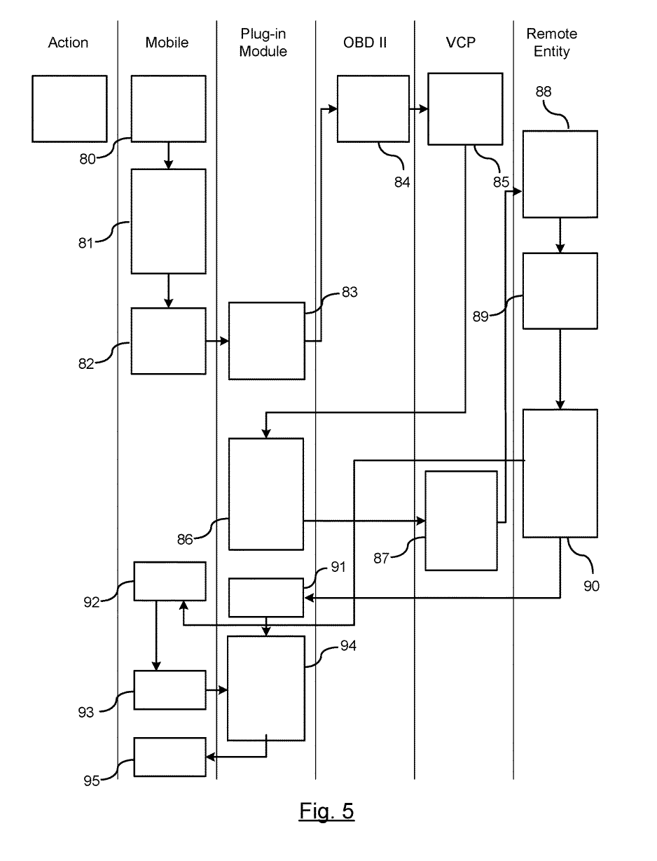

FIG. 5 represents a detection and authorization of the buyer based on the approaching portable wireless communication device 12. In block 80, in response to buyer input request or a driver approaching the vehicle 10 with the registered portable wireless communication device 12, the mobile application detects the wireless communication module 18 via, for example, a BLE broadcast. The wireless communication module 18 periodically wakes up and broadcasts a challenge signal for listening devices.

In block 81, the mobile application recognizes the received ID of the wireless communication module 18 as a valid identification for the car. The mobile application pairs a portable wireless communication device 12 to the vehicle 10.

In block 82, the mobile application notifies the wireless communication module 18 that the buyer is in close proximity to the vehicle 10.

In block 83, in response to the application notifying the wireless communication module 18 as to the proximity of the buyer, the wireless communication module 18 may send a wake-up call to components on a bus if the WiFi connection is also used as part of authentication.

In block 84, the on-board diagnostic port 30 transmits the wake-up command to the vehicle communication platform 26 hardware.

In block 85, the vehicle communication platform 26 hardware wakes up and activates the Wi-Fi node.

In block 86, the accessory device sends a request to ensure that the token has not been revoked via the vehicle communication platform 26. In some aspects, the request is transmitted from the accessory device via Wi-Fi (or similar network such as a 4G network) to the administrative system 14. Alternatively if this communication path is not available, then a check can further be performed by the mobile application in the portable wireless communication device 12.

In block 87, the request to validate the key or web token is transmitted by the vehicle communication platform 26 via the Wi-Fi/4G network.

In block 88, the request for key validation is received by the administrative system 14, and keys\token are checked to ensure that they have not been revoked by the administrative system 14 in block 89.

In block 90, validation response is transmitted to the mobile application on the portable wireless communication device 12 and\ or to the accessory device via the wireless communication module 18.

In block 91, the authorization key validation is received by the accessory device. In addition, in block 92, the authorization key validation is received by the portable wireless communication device 12.

In block 93, the authorization key received by the portable wireless communication device 12 is transmitted to the accessory device via the wireless communication module 18.

In block 94, the accessory device validates the authorization key received by the portable wireless communication device 12 using the digital signature and the public key of the administrative system 14.

In block 95, a communication is sent to the portable wireless communication device 12 to authorizing the mobile application use with the accessory device of the vehicle 10.

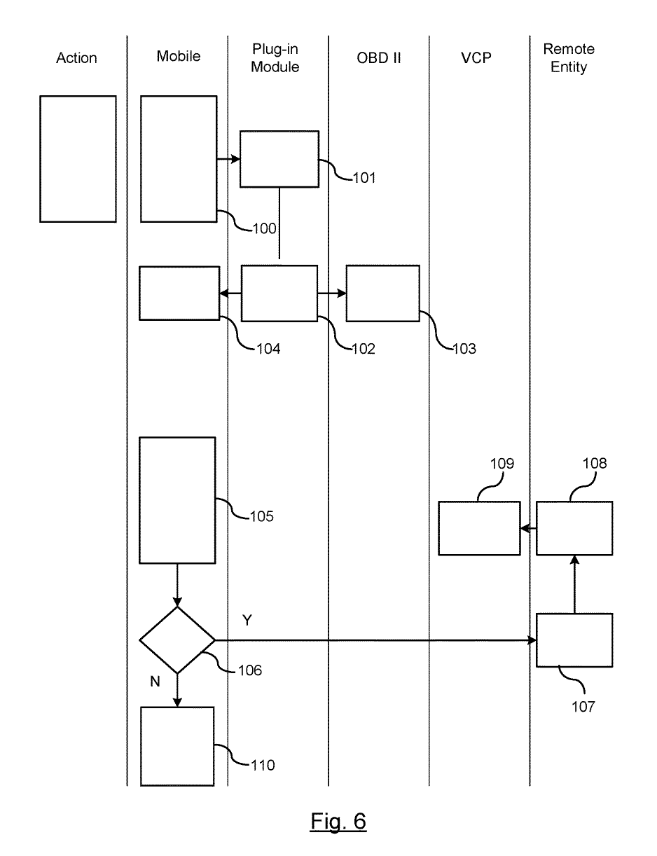

FIG. 6 is a flow diagram for executing vehicle functions typically executed by a keyfob of a vehicle as described earlier in block 43. The following steps recite short range communication between the portable wireless communication device 12 and the vehicle 10.

In block 100, a respective vehicle keyfob command (e.g., lock, unlock, remote start) is selected on the mobile application of the portable wireless communication device 12 by the buyer for executing the selected vehicle function.

In block 101, the requested command is transmitted wirelessly and received by the wireless communication module 18 of the accessory device via the antenna.

In block 102, the accessory device cues a wake-up message to be transmitted on the communication bus, which is a direct form of communication. This block is only required when the accessory device does not have a keyfob PCB that would either be added on or built-in to the main board of the accessory. If the accessory device does include a remote keyless interface, then an indirect form of communication is utilized where the accessory device commands can be sent to the fob PCB, which are then executed by the vehicle 10. This would utilize a passive entry/passive start module of the vehicle 10 coupled to the body control module 24 which is the executor of the commands. In yet another embodiment, a secure check can be utilized with either the direct or indirect form of communication as set forth above where the accessory device also wakes up the WiFi hotspot to communicate with the administrative system 14 directly to retrieve and compare administrative system 14 data with phone data and check for agreement before executing commands.

In block 103, a wake-up command is transmitted on the communication bus to the on-board diagnostic port 30 to execute the commands such as lock, unlock, sound horn, and remote start.

In addition, in block 104, a confirmation message is sent to the portable wireless communication device 12 and received via the mobile application indicating that the request has been executed.

Steps 105-110 represent a flow diagram when long range communications are required. In some instances, requests to perform a vehicle operation may occur when driver requires execution of a vehicle function prior to the buyer reaching the vehicle 10 such as remote start for heating or cooling the vehicle 10.

In block 105, a respective vehicle keyfob command (e.g., lock, unlock, remote start) is selected on the mobile application of the portable wireless communication device 12 for executing the selected vehicle function.

In block 106, a determination is made whether the requested command is a remote start. If the requested command is a remote start, the vehicle 10 advances to block 107; otherwise, the routine proceeds to block 110.

In block 107, in response to a remote start request, the administrative system 14 validates the request for remote start. In block 108, the administrative system 14 contacts a call center that is capable of accessing control over certain functions of the vehicle 10. Such systems are typically controlled by an OEM manufacturer of the vehicle 10 and offer its services through a subscription based service. This service is capable of monitoring navigation instructions to the vehicle 10, monitoring operating conditions (e.g., state-of-health) of the vehicle 10, and remotely accessing certain functions of the vehicle 10 (lock, unlock, remote start functionality), the call center is notified by the administrative system 14 of the requested command.

In block 109, the call center remotely executes the requested command to remotely start the vehicle 10 while the vehicle 10 is locked.

In block 110, in response the requested command being other than the remote start, such as a door unlock request or trunk release or sound horn, due to the proximity of the buyer to the vehicle 10, an error message may be displayed on the mobile application that the buyer needs to be closer to the vehicle 10 to execute these respective functions for security purposes.

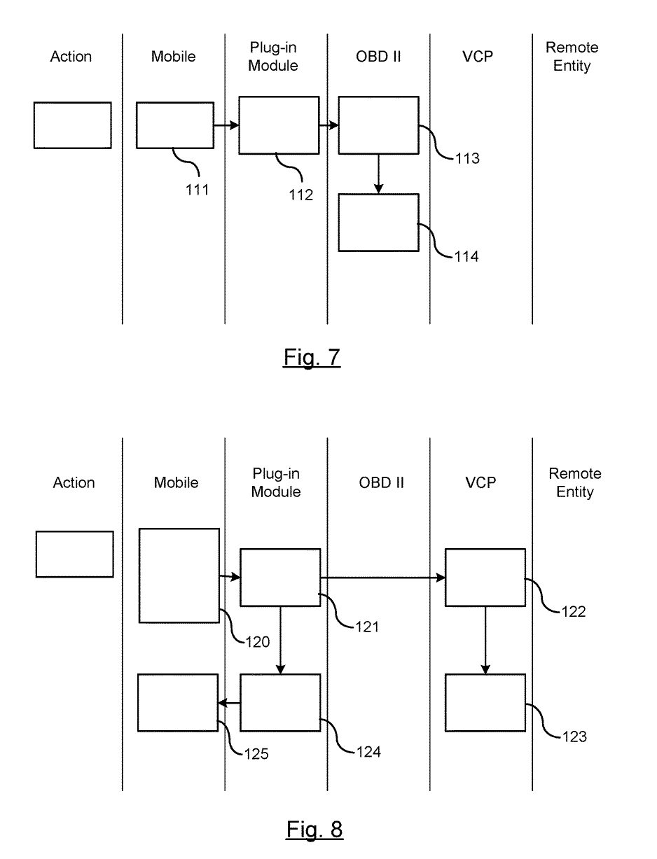

FIG. 7 is a flow diagram for executing driving functions of the vehicle 10 based on authentication between the accessory device and the portable wireless communication device 12.

In block 111, the mobile application is authorized for driving the vehicle 10. Once the buyer is within the interior of the vehicle 10, wireless communication module 18 of the accessory detects the portable wireless communication device 12 within the interior of the vehicle 10 via the BLE interior antenna.

In block 112, power is applied to the accessory device which stores the authorization keys for enabling vehicle start functions.

In block 113, a customer pushes a start button of the vehicle 10 for turning on the ignition. The passive entry/passive start functionality is executed by authorizing engine access as would be performed during a typical passive entry/passive start operation.

In block 114, the engine is turned on and the buyer is allowed to drive the vehicle 10.

FIG. 8 represents a flowchart for securing the vehicle 10 after the buyer exits the vehicle 10.

In block 120, in response to the buyer completing the trip, the buyer selects “end trip” in the mobile application or the timeout occurs. Alternatively, for security purposes, the system may sense when BLE communication is lost with the portable device. In such a situation, an assumption is made that the buyer has walked away from the vehicle 10 which may trigger the following steps so access and operation by someone attempting to steal the vehicle 10 shortly thereafter may be prevented.

In block 121, a door lock command is transmitted by the built-in module requesting a door lock command. In block 122, the door lock command is transmitted via the on-board diagnostic port 30.

In block 123, the vehicle doors are locked.

In block 124, in response to the door lock command being transmitted by the accessory device, the current authorization key is wiped from the memory of the accessory device.

In block 125, a trip end message is displayed on mobile application of the portable wireless communication device 12. Messages may be displayed on vehicle displays for start/end of trip which can be accessed via the accessory device.

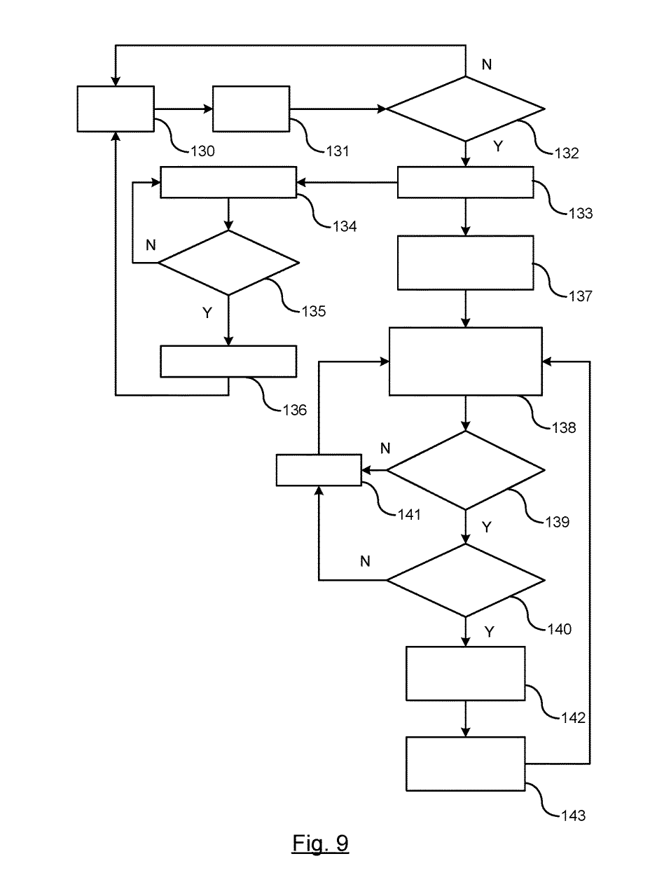

FIG. 9 is a flowchart for a software diagram for executing vehicle command functionality between the portable wireless communication device 12 and the plug-in device 16.

In block 130, the wireless communication module 18 is in sleep mode. During sleep mode, the wireless communication module 18 conserves power such that no signals are broadcast from the wireless communication module 18.

In block 131, the wireless communication module 18 awakens to detect a nearby device attempting to communicate with the wireless communication module 18.

In block 132, a determination is made whether the portable wireless communication device 12 connection is present. If the determination is made that the phone connection is not present, then the routine returns to block 130 and the wireless communication module 18 enters sleep mode. If the determination is made that a phone connection is present, then routine proceeds to block 133.

In block 133, a system boot (e.g., a dedicated microcontroller such as a 16-bit microcontroller with a reduced instruction set computing architecture) is initiated and power is allocated to a respective antenna for monitoring respective communications.

In the flowchart as shown, two respective paths are taken. A first path is directed to block 134 where the Controller Area Network is monitored for communication. In block 135, a determination is made whether a timeout is present. The timeout occurs if no communication is present on the Controller Area Network after a predetermined amount of time. If the determination is made that no communication is present on the Controller Area Network, then the routine performs a system shutdown in block 136 and the wireless communication module 18 returns to sleep mode. If the determination is made that the communication is present on the Controller Area Network, then the routine continuously loops between block 134 and 135 verifying the communication is ongoing on the Controller Area Network.

The second path proceeds to block 137 where processors within respective modules (e.g., accessory device host processor, optionally bus wakeup commands sent to wake up the body control module 24 and vehicle communication platform 26) are energized. Communications may be sent to a administrative system 14 to request authentication keys if desired. The authentication keys are sent by the administrative system 14 to both the portable wireless communication device 12 and optionally the accessory device. Keys may be sent using a JSON Web Token format.

In block 138, the accessory device waits for a package provided by the portable wireless communication device 12 that includes an authorization key. When the package is received, the contents of the package are unpacked.

In block 139, a determination is made as to whether a valid authorization key is provided by the portable wireless communication device 12. If the determination is made that a valid authorization key is provided, then the routine proceeds to block 140; otherwise, routine proceeds to block 141. In block 141, a failure message is sent to the portable wireless communication device 12 and a return is made to block 138 to await a next package transmitted by the portable wireless communication device 12.

In block 140, a determination is made whether a valid command request is received by the portable wireless communication device 12. If the valid request is received by the portable wireless communication device 12, then the routine proceeds to block 142; otherwise, the routine proceeds to block 141 where a failure message is sent to the portable wireless communication device 12.

In block 142, a confirmation is sent to the portable wireless communication device 12 that the request is successfully received and authorized. The accessory device communicates via remote keyless module to the body control module 24 to power up the respective functions.

In block 143, the body control module 24 executes the requested command (e.g., lock door, unlock door, horn, release trunk).

In some aspects, systems and methods of the present disclosure provide for a transaction involving the on-sale vehicle 10 include registering a buyer, providing an on-sale vehicle, receiving an access request for the on-sale vehicle 10, approving the access request, transmitting at least one authentication key, confirming an identity of the buyer, initiating a test drive, monitoring the test drive, and completing a transaction upon conclusion of the test drive. The buyer is registered via administrative system. The on-sale vehicle 10 provided matches search criteria entered by the buyer and is provided in response to a buyer query. The access request is received in response to selection by the buyer. The access request is approved in response to seller input received via the vehicle-administration module. The authentication keys are transmitted to at least one of the portable wireless communication device 12 and the plug-in device 16 and are transmitted in response to approving the access request. The identity of the buyer is confirmed in response to an access notification received by the administrative system 14. The test drive is initiated in response to confirming the identity of the buyer. The test drive is monitored via the driver-monitoring module. Completing the transaction upon conclusion of the test drive includes either revoking the at least one authentication key in response to the buyer not purchasing the on-sale vehicle 10 or revoking an authentication key of a prior titleholder in response to the buyer purchasing the on-sale vehicle 10. Beneficially, completing the transaction by revoking either the at least one authentication key associated with the buyer or the authentication key of the prior titleholder improves vehicle security by ensuring that the two parties do not have simultaneous access to the on-sale vehicle 10 or personal items therein.

In some aspects, registration requires credit validation via credit-validation module. In some aspects, the authentication key of the prior titleholder is contained within a keyfob.

In some aspects, approving the access request includes receiving a seller input via a user interface.

In some aspects, approving the access request includes automatically approving the access request via an approval module in response to the access request meeting one or more predetermined criteria. In some aspects, the predetermined criteria include vehicle availability such as a timeframe in which the vehicle 10 is not in use by the titleholder. In some aspects, the predetermined criteria include the buyer being above a creditworthiness threshold, placing a security deposit on the on-sale vehicle 10, and the like.

In some aspects, confirming the identity of the buyer includes use of the driver-facing camera. In some aspects, the driver-facing camera captures an image of an identification card such as a driver's license presented to the camera. In some aspects, the driver-facing camera captures an image of the driver's face and compares that to a known image of the expected driver.

In some aspects, initiating the test drive of the on-sale vehicle 10 includes voice communication with the seller. In some aspects, the voice communication with the seller occurs via a video call using the driver-facing camera. In some aspects, the video call includes display of the seller via a video display within the on-sale vehicle 10.

In some aspects, monitoring the test drive of the on-sale vehicle 10 via the driver-monitoring module includes use of the telematics module for tracking information about the on-sale vehicle 10 during the test drive. In some aspects, monitoring the test drive of the on-sale vehicle 10 via the driver-monitoring module includes use of additional cameras on the vehicle 10, such as a front-facing vehicle camera, to transmit captured images to the seller.

In some aspects, completing the transaction includes receiving electronic payment information via in-vehicle equipment and transferring ownership of the on-sale vehicle 10 to the buyer.

In some aspects, the transaction also includes the seller changing a vehicle setting unrelated to vehicle performance. For example, the seller may have control over radio volume, climate controls, comfort features, warning lights, combinations thereof, and the like.

Beneficially, systems and methods disclosed herein allow a vehicle titleholder to maintain access to and personal use of the vehicle 10 prior to the buyer purchasing the on-sale vehicle 10. As used herein, “seller” can include an actual or potential seller, vehicle titleholder, and/or agents thereof, as context dictates. Also as used herein, “buyer” can include an actual or potential buyer and/or agents thereof as context dictates.

Beneficially, systems and methods in accordance with the present disclosure provide for an optimized sale process.

While the best modes for carrying out the disclosure have been described in detail, those familiar with the art to which this disclosure relates will recognize various alternative designs and embodiments for practicing the disclosure within the scope of the appended claims.

What is claimed is:

1. A method comprising:
receiving, in response to selection by a buyer, an access request for an on-sale vehicle;
approving, via a vehicle-administration module, the access request;
transmitting, in response to approving the access request, at least one authentication key to at least one of a portable wireless communication device and a plug-in device attached to the vehicle to enable vehicle access and vehicle operations for the on-sale vehicle by the buyer using the portable wireless communication device;
confirming, in response to an access notification received by the administrative system, an identity of the buyer using a credential validation module;
monitoring, via a driver-monitoring module, a test drive of the on-sale vehicle; and
completing, upon conclusion of the test drive, a transaction by:
revoking, in response to the buyer not purchasing the on-sale vehicle, the at least one authentication key, and
revoking, in response to the buyer purchasing the on-sale vehicle, an authentication key of a prior titleholder.

2. The method of claim 1, further comprising performing an initial setup of the plug-in device in the vehicle including pairing the plug-in device as an additional keyfob to the vehicle including:
coupling the plug-in device to a service communication port of the vehicle;
accessing a vehicle communication platform (VCP) of the vehicle;
pairing the plug-in device to a passive entry/passive start system of the vehicle;
requesting cryptography keys from a remote entity via the VCP for validation between the plug-in device and the passive entry/passive start system; and
successfully pairing the plug-in device to the passive entry/passive start system for ongoing communication between the plug-in device and passive entry/passive start system.

3. The method of claim 1, wherein the prior titleholder maintains access to and personal use of the on-sale vehicle prior to the buyer purchasing the on-sale vehicle.

4. The method of claim 1, wherein the authentication key of the prior titleholder is contained within a keyfob.

5. The method of claim 1, wherein approving the access request includes automatically approving the access request via an approval module in response to the access request meeting one or more predetermined criteria.

6. The method of claim 5, wherein the predetermined criteria include vehicle availability.

7. The method of claim 1, wherein confirming the identity of the buyer includes use of a driver-facing camera installed within the vehicle.

8. The method of claim 7, wherein confirming the identity of the buyer includes capturing, via the driver-facing camera, an image of an identification card presented to the driver-facing camera.

9. The method of claim 7, wherein confirming the identity of the buyer includes:
capturing, via the driver-facing camera, an image of a face of the buyer; and
comparing, via the administrative system, the image to a known image of the face of the buyer.

10. The method of claim 1, further comprising:
registering, via an administrative system, a buyer;
providing, in response to a query initiated by the buyer, indicia of an on-sale vehicle matching search criteria entered by the buyer; and
initiating, in response to confirming the identity of the buyer, a test drive of the on-sale vehicle,
wherein the plug-in device is configured to enable vehicle access and vehicle operations for the on-sale vehicle.

11. The method of claim 10, wherein initiating the test drive of the on-sale vehicle includes voice communication with the seller.

12. The method of claim 11, wherein the voice communication with the seller occurs via a video call using a driver-facing camera installed within the on-sale vehicle.

13. The method of claim 12, wherein the video call includes display of the seller via a video display within the on-sale vehicle.

14. The method of claim 1, wherein monitoring the test drive of the on-sale vehicle via the driver-monitoring module includes using a telematics module to track information including position of the on-sale vehicle during the test drive.

15. The method of claim 1, wherein monitoring the test drive of the on-sale vehicle via the driver-monitoring module includes transmitting images captured by a front-facing vehicle camera to the seller.

16. The method of claim 1, further comprising automatically modifying a vehicle setting unrelated to vehicle performance in response to a seller input via the vehicle-administration module.

17. The method of claim 16, wherein the vehicle setting includes actuation of exterior lights.

18. The method of claim 1, wherein the seller is monitoring, via a driver-monitoring module, the test drive of the on-sale vehicle is performed by the seller, and wherein the seller simultaneously monitors, via a second driver-monitoring module, a second test drive of a second on-sale vehicle.

19. The method of claim 1, wherein completing, upon conclusion of the test drive, the transaction further includes transmitting, via a communication module, data describing the test drive to the seller.

20. The method of claim 1, wherein completing, upon conclusion of the test drive, the transaction further includes transmitting, via a communication module, data describing the test drive to the buyer.
